(19) United States
(12) Patent Application Publication
(10) Pub. No.: US 2011/0162361 A1
(43) Pub. Date: Jul. 7, 2011

(54) METHOD OF SUPERHEATING TEAM

(76) Inventor: Reinhard Schu, Walkenried (DE)

(21) Appl. No.: 13/059,980

(22) PCT Filed: Aug. 31, 2009
(86) PCT No.: PCT/DE2009/001225

§ 371 Date: Feb. 25, 2011

(30) Foreign Application Priority Data
Sep. 19, 2008 (DE) 10 2008 048 096.7

(51) Int. Cl. F03G 6/06; F24J 2/30; F24J 2/12

(52) U.S. Cl. 60/641.11; 60/641.15; 126/643; 126/694

(57) ABSTRACT

The invention relates to a method for solar overheating of vapour produced by solar energy, using different solar heat producers, wherein the process with the lower maximum possible temperature is essentially used for vapour production and the process with the higher maximum possible temperature is essentially used for vapour overheating.

The invention relates to a method of solar superheating solar-generated steam.

The simple water-steam cycle of a conventional power plant is composed at least of a feed-water pump, a steam generator, a turbine, and a condenser. The feed-water pump supplies water to a steam generator, which can for example be a boiler, in which water is heated by means of a fuel. The steam produced for example drives a power-generating turbine. Subsequently, the steam is condensed in a condenser so that the water produced can be recirculated. The efficiency of a heat engine of this type depends on the highest and lowest temperatures in the system, and efficiency increases as the temperature differential increases. With the growing shortage of raw materials and in particular for environmental reasons, it is in the general interest to improve the degrees of efficiency of existing power plants and to thus increase their efficiency.

For example, from DE 10 2005 036 792 [US 2009/0077971] a method of generating superheated steam is known, where a main plant generates essentially saturated steam or wet steam that is superheated in an auxiliary plant whose superheater is regulated depending on the steam production of the main plant. The proposed method is used above all to increase the electrical efficiency of substitute fuel plants or nuclear power plants.

According to the prior art, solar-energy utilization plants are also known that use solar energy to heat a thermal oil as a heat-exchange medium that in turn evaporates water in the water-steam cycle. However, thermal oils currently known are thermally unstable and can be heated only to temperatures below 400° C. Recently, instead of the thermal oil, molten salt is used as a heat-exchange medium, permitting a much higher output temperature.

The object of the present invention is to provide a method with which the efficiency of steam power machines is further increased, and at the same time pollution is avoided.

This object is attained according to the method according to claim 1. According to the invention different solar-energy generators are used for the solar superheating of solar-generated steam, with the process with the low maximum possible temperature being used essentially for steam generation and the process with the higher maximum possible temperature being used essentially for steam superheating. Preferably, hot air generated from the process with the higher possible temperature is further improved by the use as fresh air in a combustion process and heated to even higher temperatures and to produce a higher degree of efficiency in the steam process. Advantageously, to superheat steam in a water-steam cycle of a steam-power plant, at least two different solar-energy generators are used, steam being generated by a first solar-energy generator and the steam being superheated by a second solar-energy generator.

The efficiency of the steam-power plant can be increased by the use of different solar-energy generators for heating water and superheating steam, since the individual processes can be optimally adapted to the respective conditions independently of one another and of the temperature.

According to a special embodiment, the first solar-energy generator is a parabolic trough system with thermal oil as its heat-exchange medium. A parabolic trough system is composed of an elongated parabolic reflector that can focus parallel incident light at a focal point. A conduit is arranged at the focal point, and a heat-exchange medium is conducted and heated by the action of solar radiation. Thermal oil, for example, can be used as a heat-exchange medium. Although it is known that thermal oils can be heated only to temperatures up to a maximum of 400° C., in particular parabolic trough systems with thermal oils can be of very large dimensions so that based on the size they have a high technical optimization potential with a water-steam cycle by using multistage condensate preheating and feed water preheating, for example.

A solar tower or a parabolic trough system is preferably provided as the second solar-energy generator with molten salts as a heat-exchange medium. Molten salts are ionic liquids that permit an output temperature of currently up to 565° C. so that steam can be superheated with them.

According to a further embodiment hot air is generated by solar towers with receivers that support steam superheating. A solar tower has a tower in which the medium to be heated flows along or is stored several meters above the ground. Many hundred to a thousand moveable reflectors are arranged around the tower and can be aligned such that they can focus incident solar rays at one point. The heat-exchange medium can thus be heated inside the tower. With direct air preheating, temperatures of 700° C. to 1000° C. can be produced so that the superheating of the steam can be further increased.

A concrete illustrated embodiment is explained below with reference to the figures. Therein:

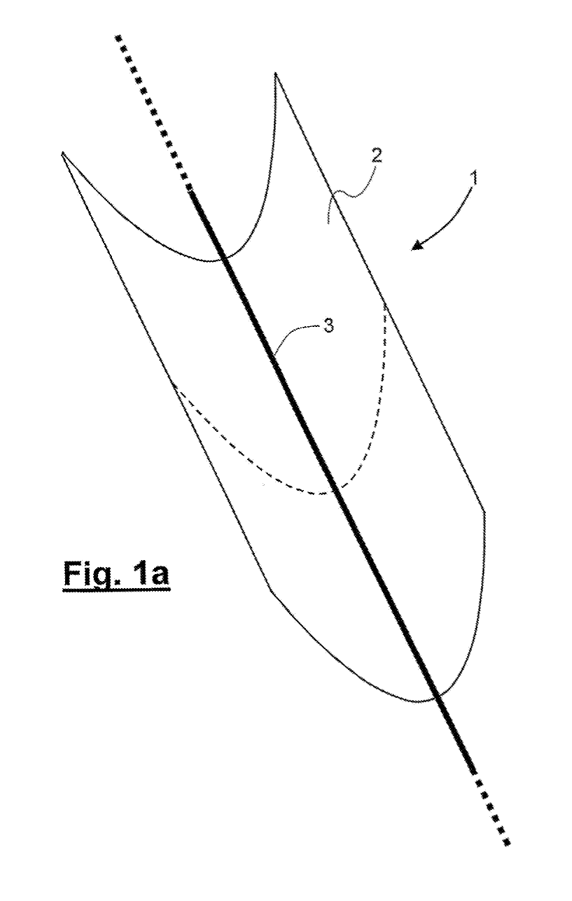

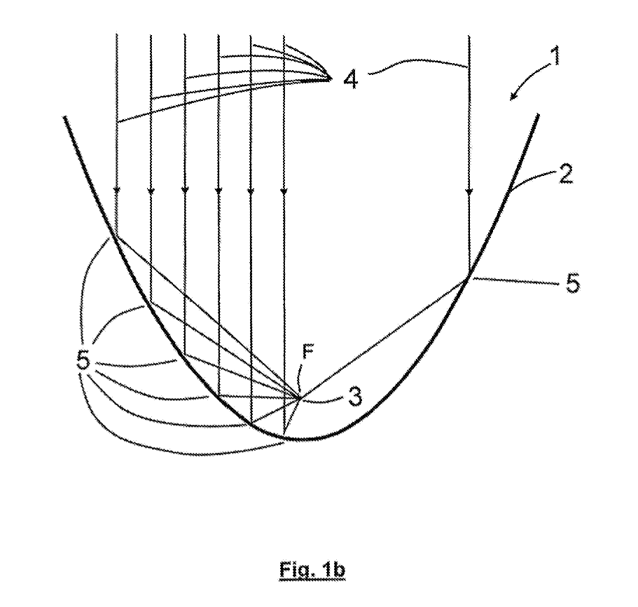

FIG. 1a is a perspective view of a parabolic trough,

FIG. 1b is a cross section through a parabolic trough,

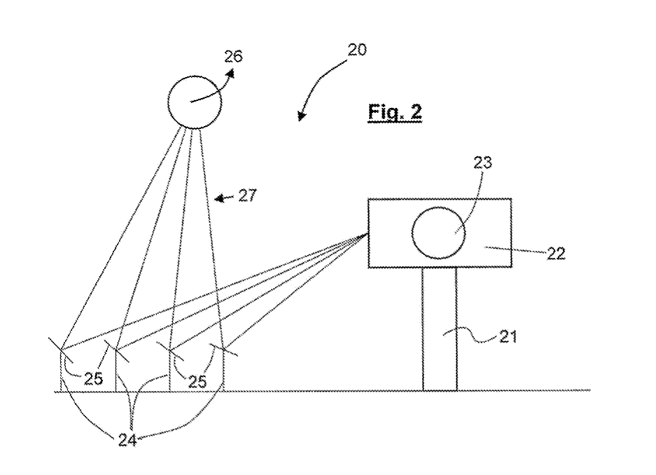

FIG. 2 shows a solar tower plant, and

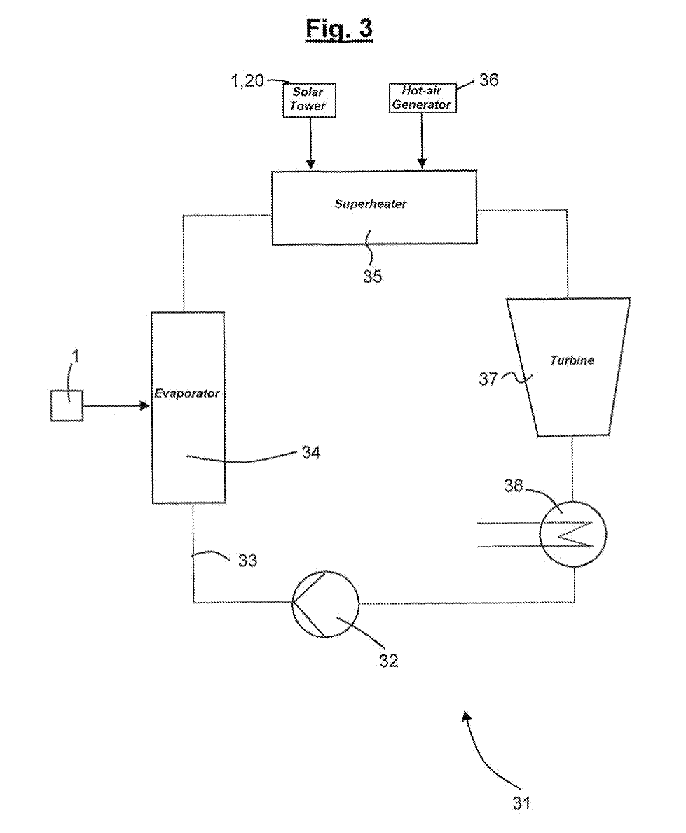

FIG. 3 is a diagrammatic view of water-steam cycle.

A parabolic trough system 1 has at least one parabolic reflector 2 whose focal point F lies on a line 3 where a heat-exchange medium flows. Parallel incident sunlight 4 is reflected by the parabolic reflector 2 at the points 5 such that the light is focused at the focal point F, the focal point F (or in this case the focal line) lying on the line 3. In principle, systems of this type can be scaled as large as desired. In particular, the length of a parabolic trough 2 is hardly limited, and it is also known to arrange several parabolic troughs next to one another.

A solar tower system 20 is composed of a tower 21 on which a receiver 22 is provided to which the heat-exchange medium is conducted by a pipeline 23. Reflector units 24 are arranged around the solar tower that have respectively aimable reflectors 25. The light emitted by the sun 26 is directed by the aimable reflectors onto the receiver 22 of the solar tower to heat the heat-exchange medium.

A possible process sequence is shown by way of example and diagrammatically in FIG. 3. The water-steam cycle or loop 31 has a feed-water pump 32 that circulates the water in a pipeline 33. The water is evaporated in an evaporator 34 that is supplied with solar energy via a parabolic trough system 1 with thermal oil as a heat-exchange medium. The steam produced is subsequently superheated in a superheater 35. The energy necessary for this purpose can be generated, for example, by a parabolic trough system 1 or a solar tower 20 with molten salt as the heat-exchange medium. The superheating is supported by a hot air generator 36, which likewise can be a solar tower system. Downstream in the io circulation path, the superheated steam drives a turbine 37 in which kinetic energy is converted into electric energy or into heat. Subsequently, the steam is condensed in a condenser 38 so that the feed-water pump 32 can pump the water back into the water-steam cycle 31.

1. A method of solar superheating solar-generated steam with different solar-energy generators, wherein the generator with the low maximum possible temperature is used essentially for steam generation and the generator with the higher maximum possible temperature is used essentially for steam superheating.

2. The method according to claim 1, wherein the hot air generated from the generator with the higher possible temperature is further supplemented by use as fresh air in a combustion process and raised to even higher temperatures and degrees of efficiency in the steam generator.

3. The method according to one claim 1, wherein two different solar-energy generators are used to superheat steam in a water-steam cycle of a steam-power plant, namely a first solar-energy generator and a second solar-energy generator for superheating the steam.

4. The method according to claim 1, wherein the first solar-energy generator is a parabolic trough system with thermal oil as its heat-exchange medium.

5. The method according to claim 1, wherein the second solar-energy generator is a solar tower or a parabolic trough system with molten salt as its heat-exchange medium.

6. The method according to claim 1, wherein hot air is generated by solar towers with receiver technology that supplements steam superheating.
